(19) United States
(12) Patent Application Publication
(10) Pub. No.: US 2019/0012161 A1
(43) Pub. Date: Jan. 10, 2019

(54) DISTRIBUTED AND SELF-DELETING APPARATUS FOR FAST SOFTWARE DEPLOYMENT AND UPGRADE IN A NETWORK

(71) Applicant: BANK OF AMERICA CORPORATION, Charlotte, NC (US)

(72) Inventor: Jerzy Miernik, Allen, TX (US)

(21) Appl. No.: 15/643,669

(22) Filed: Jul. 7, 2017

(51) Int. Cl. G06F 9/445; H04L 29/08; H04L 12/24

(52) U.S. Cl. CPC G06F 8/65; H04L 67/42; H04L 41/082; H04L 67/34

(57) ABSTRACT

Embodiments of the present invention provide a system for a parallel distributed and self-deleting network deployment of network services designed to improve the speed and processing efficiency of such deployment. The system according to embodiments of the present invention issues instructions to client devices via network shells scripts issued in parallel over a number of network shells. The network shell scripts instruct the client devices to download or copy an auxiliary executable file and in some instances, a system application file. The client devices then execute the auxiliary executable files to implement a network job, allowing for parallel deployment of network services with minimal involvement from the system.

### FIELD

The present invention relates to systems, methods, and computer program products for a parallel distributed and self-deleting network deployment of network services designed to improve the speed and processing efficiency of such deployment.

### BACKGROUND

In large enterprise businesses, different software systems (otherwise referred to as applications, modules and the like) are deployed for the purpose of carrying out prescribed actions. For example, an enterprise may deploy one or more software systems to monitor the health of the computing system, one or more other software systems to move data throughout the enterprise and one or more other software systems for messaging. All of these software systems are stacked on the servers within the enterprise to carry out the request functionality. Each of these software systems are generally independent of each other; i.e., different commercial manufacturers and/or execute under different operating systems. As such, these diverse software systems may require a high degree of Information Technology (IT) support and maintenance to ensure that the systems are capable of working in unison. Additionally, each of these independent software systems implement distinct tracking controls and governance, which further increase management complexity and maintenance costs.

Further, in many large enterprises, computing servers or other networked devices are distributed globally across a diverse computing network infrastructure. The various servers deployed in the network implement many different operating systems that execute a myriad of different software packages, applications, tools and the like. In many instances a single server may host many different software packages, applications or the like.

Further, in large enterprises, with many different computing environments and business units/lines-of-business (LOBs), timely deployment of services and/or the updating/patching of such services can be highly problematic. This is because the data associated with servers, business units/LOBs and other data relevant to deploying the updates is spread across many different data sources and the like.

Therefore, a need exists to develop systems, apparatus, computer program products, methods and the like that for a unified and comprehensive service delivery system that is extensible and provides one methodology for accessing Operating Systems (OSs) and all of the servers deployed throughout an enterprise. Further, a need exists to increase the speed and reduce the necessary processing power for the deployment of services and updates to such services.

### BRIEF SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments the present invention in a simplified form as a prelude to the more detailed description that is presented later.

Generally, systems, methods, and computer program products are described herein for a distributed and self-deleting network deployment of network services. More specifically, embodiments of the invention described herein provide a fast and effective deployment of network services that can be scaled to deploy services to a large number of devices without appreciably increasing the time or processing power required to perform the deployment of network services. By delegating part or all of the deployment of network services to the client devices operating in parallel, the system reduces the amount of time and processing power required by a network management system to deploy network services.

In one embodiment of the invention, the system is configured to initiate a network deployment job, wherein the network deployment job comprises the deployment of network services to one or more client devices connected over a network; to determine a number of network-connected client devices on which the deployment of services is to occur; and to create a network shell script for each network-connected client device, wherein the network shell script transmits instructions over a network shell to a client device to download packaged job files, wherein the packaged job files comprise at least an auxiliary executable file instructing the client device to implement the network deployment job.

In another embodiment of the invention, the packaged job files further comprise a system application file and instructing the client device to implement the network deployment job comprises implementing the system application file.

In another embodiment of the invention, the auxiliary executable file comprises an instruction to self-delete once the network deployment job has been completed on the client device.

In another embodiment of the invention, the system is configured to transmit the auxiliary executable file and the system application file over the network shell.

In another embodiment of the invention, the network shell script further comprises instructions for the client device to execute the auxiliary executable file.

In another embodiment of the invention, transmitting the instruction to the client device to download packaged job files comprises transmitting instructions for the client device to download the auxiliary executable file and the system application file from a file repository server, wherein the instructions to download comprise an address of the location for the auxiliary executable file and the system application file.

In another embodiment of the invention, the network deployment job is a system upgrade, and the system application files comprise code to upgrade a network application.

In another embodiment of the invention, the network deployment job is a system downgrade, and the auxiliary application file comprises instructions to delete code from a network application.

### BRIEF DESCRIPTION OF THE DRAWINGS

Having thus described embodiments of the invention in general terms, reference will now be made to the accompanying drawings, where:

FIG. 1 is a diagram illustrating an exemplar environment of the system, in accordance with embodiments of the present invention.

FIG. 2 is a diagram illustrating an alternative embodiment of the invention wherein packaged job files are retrieved from a file repository server, in accordance with embodiments of the present invention.

FIG. 3 is a flowchart illustrating a general process flow for a system implementing a network deployment job, in accordance with embodiments of the present invention.

FIG. 4 is a flowchart illustrating a general process flow for a client device implementing a network deployment job, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for a distributed network management system for deployment of services (i.e., system upgrades, downgrades, installs, uninstalls, patches, bug fixes and the like). Embodiments of the present invention provide for parallel-operated network operations that greatly reduce the amount of time and processing power required by a network management system for network-wide deployment of services. In this regard, the system allocates the bulk of the deployment processing to the local client devices, thereby reducing the amount of time and number of operations required on the network management system conducting the roll-out of services. This “off-loading” of processing to the individual client devices, among other things, increases the execution speed of the network-wide deployment as processing occurs in parallel at each client device (making deployments and/or upgrades occur simultaneously, and thus, faster), allows for more job execution at the network management center, and shortens apparatus development time and improves its quality.

In a typical deployment of network services, a network management system uses network shell scripts to direct client devices throughout the deployment of the services. In such a system, the network management system must constantly or periodically issue instructions (i.e., scripts) to the client device that instruct the client device as to how to download, install, delete, or otherwise operate during the deployment of network services. In this typical operation, the network management system is required to perform a large number of operations, taking a significant amount of time. As more client devices are added to the network, the amount of time and processing power required to complete a deployment of network services greatly increases. The present invention solves this problem by delegating much of the processing to the client devices.

In contrast, embodiments of the present invention leverage the parallel processing power of a network of client devices to deploy network services to the client devices. By design, embodiments of the present invention minimize the role of network management systems in the deployment of network services; instead delegating tasks to the individual client devices in the network. More specifically, the network management system's role in the deployment of such services can be limited to simply creating a communication channel (i.e., a network shell) with each client device and an instance of a network shell script for each client device that instructs the client device to copy or download files, install files, uninstall files, etc. to implement the deployed services. The files include a system application file comprising the network services to be deployed and an auxiliary executable file that allows the client device to substantially implement the deployed services with minimal interaction with the network management system. As such, the deployment of network services across a wide number of client devices takes substantially the same amount of time and the same amount of processing power as the deployment of services to only a few devices. Moreover, the auxiliary executable file can be configured to self-delete upon completion of the network deployment job on the local client device. Thus, the present invention is able to utilize the parallel processing power of a network of client devices without substantially increasing the data storage footprint on the client devices themselves. Specific embodiments will be described in more detail herein with reference to the accompanying figures, demonstrating how the advantages of the present invention are achieved.

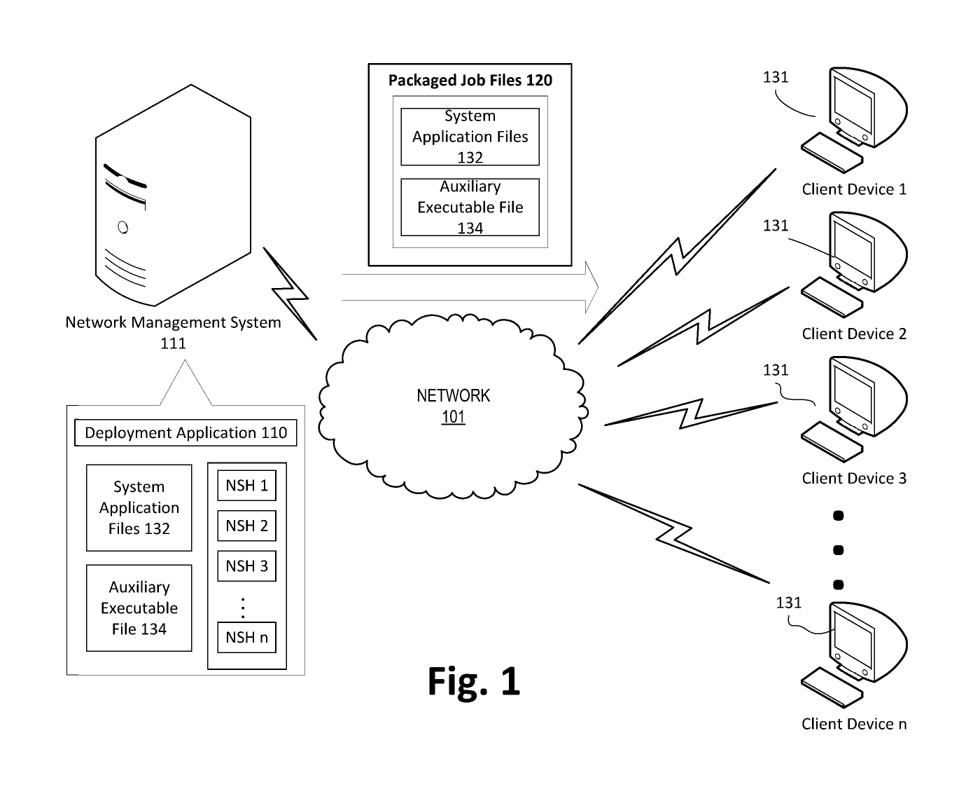

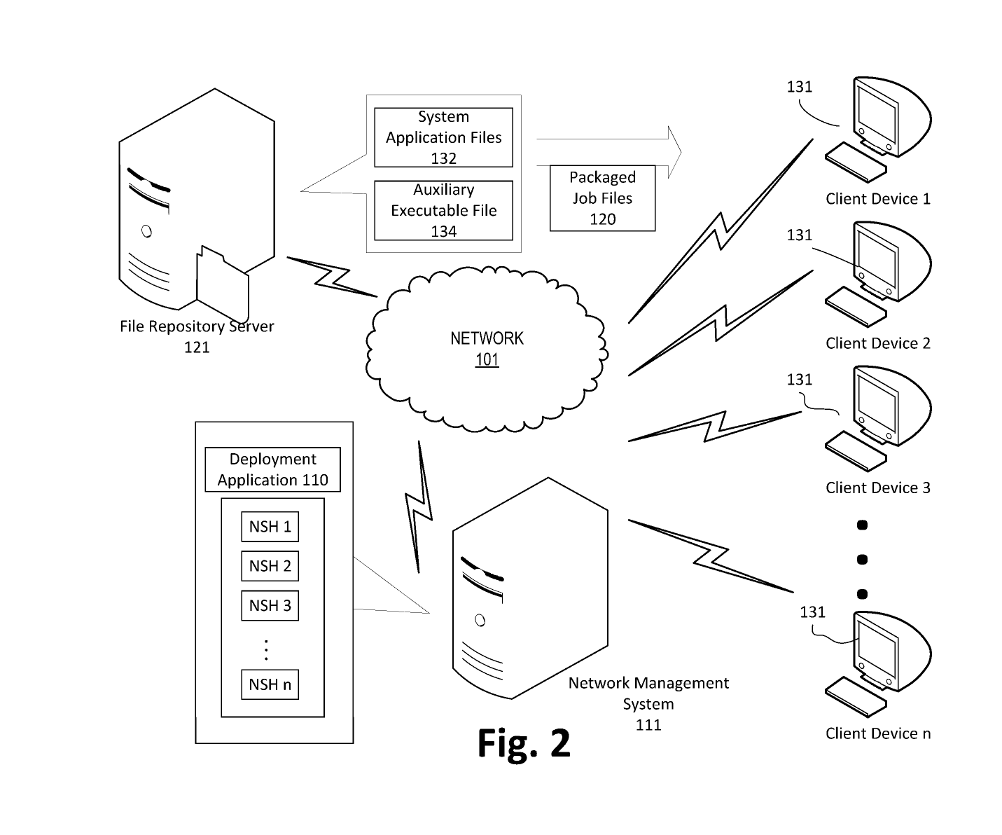

Referring to FIG. 1, a schematic diagram of a system encompassing an embodiment of the present invention is provided. As depicted in FIG. 1, a series of client devices 131 are connected to a network 101. The network also includes one or more network management systems 111 and one or more file repository servers (further illustrated in FIG. 2). Any number of client devices 131 may be connected on the network. As will be explained in greater detail below, one of the primary benefits of the present invention is its ability to add client devices without appreciably increasing the amount of time or the system resources required to deploy network services to the additional client devices 131.

The network management system 111 is responsible for management of the client devices, repository servers, and other devices connected to the network 101. One of the responsibilities of the network management system is initiating a network deployment job. As used herein, a network deployment job is the deployment of network services issued from the network management system 111 to one or more client devices 131. The network deployment job may instruct the client devices 131 to upgrade or downgrade a system application, roll back to a previous version of a system application, issue a security patch to the system application, fix bugs in the system application, or otherwise instruct the client device 131 to perform operations. In this regard, a network deployment job may be initiated by a network administrator through the network management system 111, automatically based on the occurrence of some predetermined condition, initiated periodically (e.g., weekly, monthly, or the like), or otherwise initiated either by user operation or other triggering mechanism. The network management system 111 uses network shells to communicate with and direct the client devices during job deployment. A network shell as used herein is a tool (i.e., a series of computer implemented instructions) that allows a network of connected devices to operate as a single host. In that regard, each network shell acts as a communication channel between the network management system 111 and an individual client device 131, allowing the network management system 111 to provide instructions (e.g., via a network shell script) to the client device 131 and receive communications therefrom. Embodiments according to the present invention use network shell scripts issued over the network shells to instruct client devices 131 to perform operations. Commonly used network shell tools such as BladeLogic® may be used in implementing the network shell, though it will be understood that any network shell tool may be used to implement the network shell scripts.

As shown in FIG. 1, the network management system 111 comprises at least a deployment application 110, and a network shell for each client 131 device on the network (NSH 1, NSH 2, NSH 3, NSH n). Also shown in FIG. 1, the network management system 111 may further comprise system application files 132 and auxiliary executable files 134. In some embodiments, as described in greater detail with reference to FIG. 2, the system application files 132 and auxiliary executable files 134 may be located in a file repository server 121 instead of on the network management system 111. The deployment application 110 include software instructions that when operated on by the network managements system cause the system to initiate a network deployment job as described above, and for obtaining the parameters of the network deployment job (e.g., number of client devices, software upgrade or downgrade versions, and the like). The deployment application 110 may also include software instructions regarding communication with the at least one network shell to receive periodic updates regarding the status of the network deployment job. Aside from initiating the network deployment job and receiving periodic updates on the status of the network deployment job, the tasks performed by the network management system are kept to a minimum in order to reduce the demands on the network management system. In that regard, the network management system 111 via the deployment application 110 creates an instance of a network shell for each client device 131 involved in the network deployment job, and leaves the bulk of the processing for the network deployment job to the client devices 131.

The network shell for each of the client devices 131 (e.g., NSH 1 as depicted in FIG. 1) allows the network management system to transmit packaged job files 120 to the client device associated with the network shell. The network shell also allows the network management system 111 to issue network shell scripts instructing the client devices 131 to perform operations (e.g., to download/copy files). In some instances, the packaged job files 120 comprises both the system application file 132 and the auxiliary executable file 134. As used herein, the system application files are the files containing the task to be performed by the network deployment job. For example, if the network deployment job is a network application upgrade, the system application files 132 will contain the code to upgrade the network application. Alternatively, if the network deployment job is a security patch to a network application, the system application files 132 will contain the code comprising the security patch.

As used herein, the auxiliary executable file 134 is a file that comprises executable code that runs on the client device 131 to install and/or implement the system application files 132. The executable file 131 comprises all of the necessary instructions that allow the client device 131 to perform the network deployment job locally. In this regard, the auxiliary executable file 134 allows the client device to implement the network deployment job locally on the client device 131 with minimal interaction over the network with the network management system 111. As such, the demand on the resources of the network management system 111 is minimal. Moreover, the amount of time required to implement a network deployment job on a plurality of client devices 131 is significantly reduced. Instead of the network management system 111 providing instructions to each client device 131 on which the network deployment job is to be implemented, the auxiliary executable file 134 performs the network deployment job on the client device 131 itself. Thus, a network deployment job involving fifty, one hundred, or even one thousand client devices can be completed in substantially the same amount of time because each client device 131 connected to the network 101 is able to complete the job locally, and in parallel with the other client devices 131 on the network 101.

In some embodiments, the responsibility for implementing the network deployment job is shared between the network management system 111 and the client device. For example, in one embodiment of the invention, a network deployment job may comprise a network application upgrade. The auxiliary executable file 134 may include instructions for the client device 131 to perform a device restart to clear previous versions of the network application from the device memory. In this embodiment, the auxiliary executable file 134 will also contain instructions for the client device to establish communication with the network management system 111. The auxiliary executable file 134 may also send a pointer reference to the place in the client device memory where the last completed instruction is stored. Thus, when the client device 131 performs the device restart—thereby halting the execution of the auxiliary executable file 134—the network management system 111 can take over the implementation of the network application upgrade. In this regard, the network management system 111 may instruct the client device 131 to run the auxiliary executable file upon the device restart from the point where the last instruction occurred.

In some embodiments (e.g., in a network-wide downgrade), the packaged job files 120 may not include system application files 132. In such embodiments, the network deployment job can be completed entirely by the auxiliary executable file 134. For example, in a network downgrade, the network management system may send only an auxiliary executable file to the client device. The auxiliary executable file of this embodiment include computer instructions used by the client device to perform the operations dictated therein such as uninstall an application from the client device, delete code from a network application stored on the client device, or uninstall a current version of software and download a previous version.

FIG. 2 depicts an alternative embodiment of the invention wherein the system application file 132 and the auxiliary executable file 134 are stored on a file repository server 121 separate from the network management system 111. In such an alternative embodiment, the network management system will comprise the deployment application 110 and a network shell script for each client device 131 on which the deployment job will be deployed. When the deployment application 110 is launched, an instance of a network shell script (e.g., NSH 1, NSH 2, and NSH 3) is created for each client device. The network managements system will send via the network shells instructions that direct the client device to download the packaged files 120 from the file repository server 121, wherein the packaged files 120 comprise the system application file 132 and/or the auxiliary executable file 134. The instructions from the network management system may further include the address or location of the system application file 132 and the auxiliary executable file 134 stored on the file repository server 121. The address or location may be sent as a pointer reference or the like.

Embodiments of the invention according to FIG. 2 may further reduce the processing power and memory usage required of the network management system 111, as the network management system 111 will not be required to process the download of the packaged job files 120, nor store the system application files 132 and auxiliary executable files 134. Indeed, by placing the system application file 132 and the auxiliary executable file 134 on the file repository server 121, the network management system 111 will not be held up by an individual client's delay in downloading the packaged job files 120. This will allow the network management system 111 to complete a job more quickly, and move on to completing other jobs on the network.

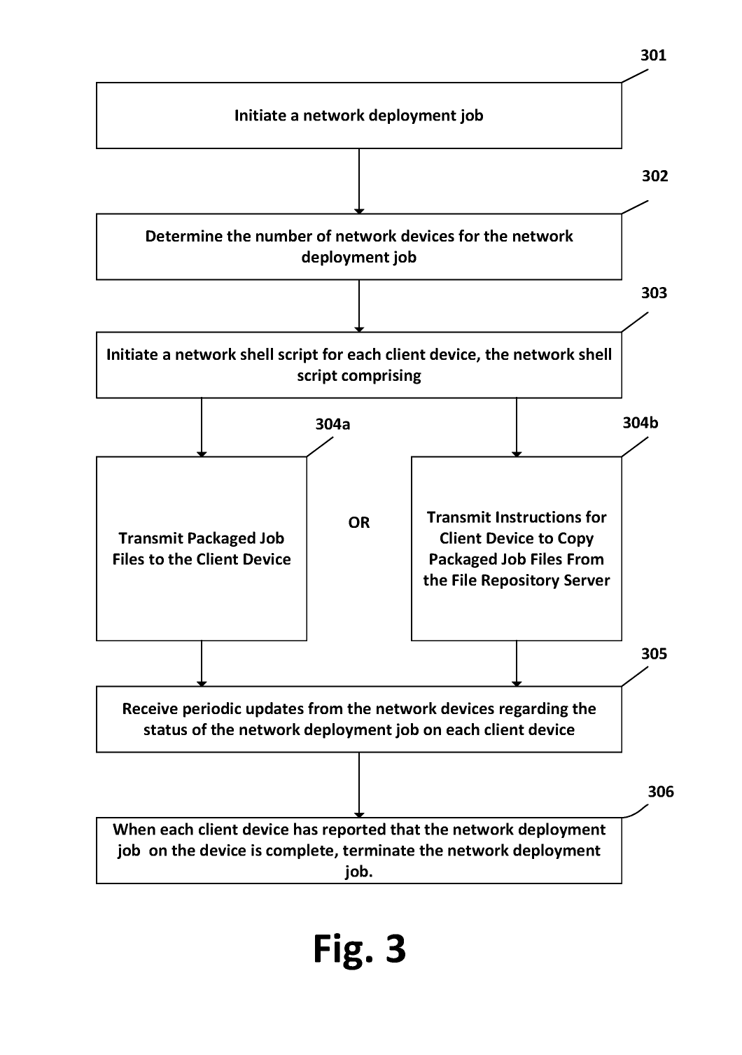

FIG. 3 is a process flow depicting the deployment application 110 in an exemplary embodiment of the invention. As shown in FIG. 3, at block 301 the deployment application 110 is launched on the network management system 111 to initiate a network deployment job. As noted previously, a network deployment job is the deployment of network services issued from the network management system 111 to the series of client devices 131. The network deployment job may be to upgrade or downgrade a system application on the client devices 131, roll back client devices 131 to a previous version of a system application, issue a security patch for the system application on the client devices, fix bugs in the system application on the client devices, or otherwise perform operations to system applications on the client devices 131. The network deployment job may be initiated by a user through the deployment application 110. In other embodiments, the system may be configured to initiate a network deployment job automatically, such as upon the occurrence of a predetermined event, periodically at a scheduled time (e.g., nightly, weekly, or the like), or as otherwise determined by the system.

At block 302, once the network deployment job has been initiated, the deployment application 110 executes code on the network management system 111 to determine the number of client devices 131 connected to the network 101 on which the network deployment job may be deployed. The system may determine the number of client devices 131 in any number of ways. In some embodiments, the system may poll the network for client devices, and receive back responses from the client devices 131 that need the network deployment job. Alternatively, a user may enter the number of client devices 131 on which to implement the network deployment job. In another embodiment, the deployment application 110 may initiate the network deployment job to a predetermined number of client devices based on system capacity.

Regardless of the method used to determine the number of client devices 131 on which the network deployment job will be deployed, at block 303 the deployment application next initiates a parallel instance of a network shell for each client device 131 determined in block 302 (i.e., if there one hundred client devices 131, the deployment application will initiate 100 parallel network shells). The network shells for each client device 131 allows the deployment application 131 to run network shell scripts on each of the client devices 131 in parallel.

As noted, the scripts the network shell scripts issued over the network shells instruct the client devices 131 to download the system application files 132 and the auxiliary executable files 134 from the file repository server 121. However, as described above, the network management system may also share some of the responsibilities of implementing the network deployment job with the client device 131, as opposed to handing off the entirety of the deployment job to the client device 131.

At block 304, the system may transmit the packaged job files 120 in one of two ways. As shown in block 304a, the network management system 111 may directly transmit the packaged job files 120 to the client devices using the network shell for that client device. In other words, the client device downloads the packaged job files 120 from the network management system 111. In block 304b, an alternative embodiment is depicted wherein the network shell script transmits instructions to the client device 131 to copy packaged job files 120 from the file repository server 121. FIG. 2 demonstrates one such embodiment where step 304b is implemented. As described with reference to FIG. 2, the instructions from the network shell script may direct the client device to an address on the file repository server 121 where the client device can go to copy the packaged job files 120, which comprise the system application file 132 and/or the auxiliary executable file 134.

As alluded to above, once the deployment application has initiated a network shell for each client device 131 and run the parallel network shell scripts, the deployment application 110 waits while the network deployment job is being completed in parallel by the client devices 131. However, the deployment application 110 may periodically receive updates from the client devices 131 regarding the status of the network deployment job. For example, the client devices 131 may send periodic updates to the deployment application indicating the progress of the network deployment job on the respective client device 131 (e.g., indicating the status of the network deployment job at predetermined time intervals), or the client devices 131 may send status updates to the deployment application upon the completion of certain deployment events (e.g., the client device 131 may send notification when the client device has initiated a download from the file repository server 121, has completed download from the file repository server 121, has initiated the auxiliary executable file, and the like). In some embodiments, the deployment application may be configured to request an update from the client device 131 (e.g., upon the request from a network administrator). When the network deployment job is completed on the client device 131, it may report to the deployment application that the job is complete.

Once the deployment application has received indication from each of the client devices 131 that all of the client devices 131 on the network 101 have completed the network deployment job, the deployment application can terminate, as depicted at block 306.

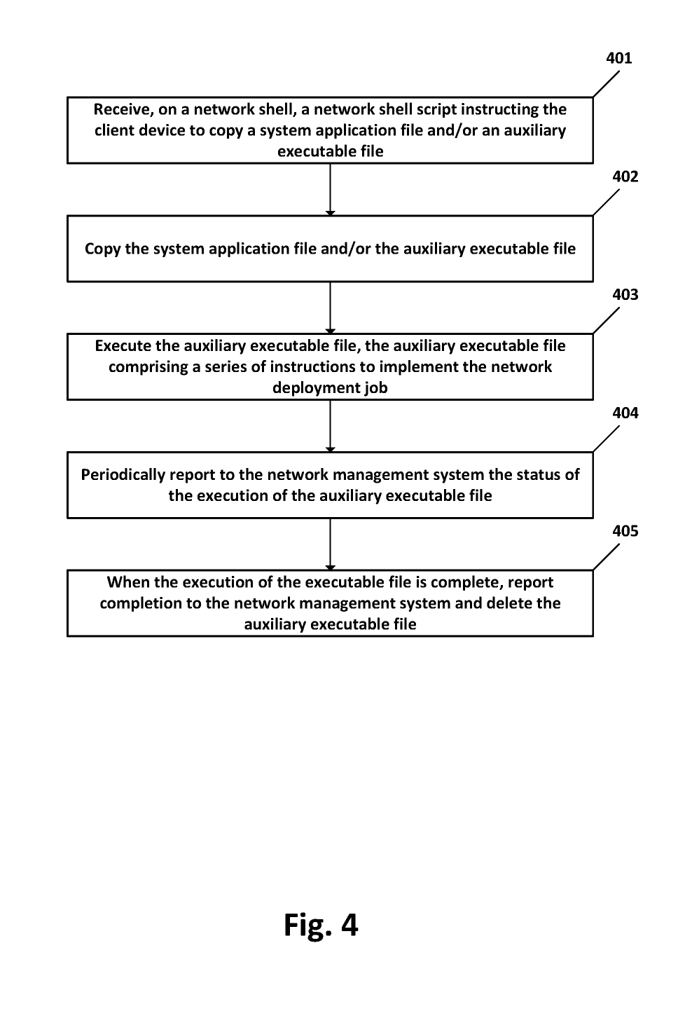

FIG. 4 is a process flow depicting the operation of a client device 131 during the deployment of network services in an exemplary embodiment of the invention. As will be understood, the process flow depicted in FIG. 4 will operate in parallel on all of the network-connected client devices 131 involved in the deployment of network services.

At block 401, the client device 131 receives, on a network shell, a network shell script from the network management system 111. As discussed above, the network shell script comprises instructions for the client device to copy a system application file 132 and an auxiliary executable file 134 from the network management system 111 or from the file repository server 121. The network shell script may additionally comprise the location (e.g., in a pointer) of the system application file 132 and the auxiliary executable file 134 on the file repository server 121 in embodiments where such files are stored on the file repository server.

At block 402, once the client device 131 has received the network shell script from the network management system 111, the client device 131 copies the system application file 132 and the auxiliary executable file 134 from the network management system 111 or the file repository server 121. In some embodiments, the system application file 132 may be quite large, and copying the file may take several minutes. In a typical system deploying network services, the network management system 111 would have to wait for each client device 131 to complete the copying of files before the executable steps to implement the deployment of services could be taken. However, and as will be discussed in greater detail herein, the present system minimizes the effect on the network management system 111 by delegating the executable steps to the client device 131 itself. Thus, a client device 131 is not affected by the status of deployment of network services on the other client devices 131 involved in the deployment.

Once the client device 131 has successfully copied the system application file 132 and/or the auxiliary executable file 134 from the network management system 111 or the file repository server 121, the client device 131 at block 403 may report to the network management system 111 that copying has been successfully completed. In some embodiments, however, the client device 131 may not need to report the successfully copying of the system application file 132 and/or the auxiliary executable file 134 in order to further reduce traffic over the network, which can slow the network deployment job.

At block 403, the system executes the auxiliary executable file 134. As noted previously, the auxiliary executable file 134 runs on the client device 131 and implements the system application file 132. In that regard, the auxiliary executable file 134 comprises all of the settings, configurations, protocols, requirements, and the like required to implement the system application file 132. For example, if the network deployment job is a system upgrade, the system application file 132 will be the upgraded system software and the auxiliary file 134 will comprise all of the requirements for the client device 131 to implement the upgraded system. In this regard, the client device 131 is able to fully self-execute and implement the system upgrade without any instruction or communication to the network management system 111. As previously noted, this greatly reduces the processing requirements on the network management system 111 and the time it takes to complete a network-wide deployment of services. Instead of the network management system 111 having to issue scripts via the network shell instructing the client devices 131 on each step of the implementation of system upgrade, the client devices 131 handle this processing themselves.

At block 404, the client device 131 reports periodic updates to the network management system 111 on the status of the execution of the auxiliary executable file (and thus, the status of the implementation of the network deployment job). Periodic updates may occur after certain events have occurred on the client device 131 (e.g., once files have been downloaded, once certain segments of the system application files have been successfully installed, and the like), at predetermined time intervals (e.g., send an update every ten seconds, every minute, and the like), or at the request of the network management system (e.g., a user request). It will be understood that the client device 131 does not have to send periodic updates at all, and may simply implement the network deployment job without communicating with the network management system 111. In some embodiments, the client device 131 may only send an update to the network management system 111 once execution of the auxiliary execution file has been completed, as shown in block 405.

At block 405, the client device completes the network deployment job by deleting auxiliary executable file 134. In some embodiments, the auxiliary executable file 134 will comprise a final instruction to delete itself. In other embodiments, once the client device 131 has reported completion of the auxiliary executable file 134, the network management system 111 will issue instructions on the network shell for the client device to delete the auxiliary executable file 134. In either embodiment, the auxiliary executable file 134 is deleted from the client device 131, thereby eliminating any memory footprint on the client device 131 caused by storing the auxiliary executable file 134. In this regard, even though the present invention makes use of the client devices 131 to implement the network deployment job, the present invention requires no more permanent memory usage on the client device 131 than if the network management system 111 instructed execution of the system application files 132 itself.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for instituting a network-wide deployment of services, the system comprising:
at least on memory;
at least one processor;
computer programmable code stored on the at least one memory configured to cause the at least one processor to:
initiate a network deployment job, wherein the network deployment job comprises the deployment of network services to one or more client devices connected over a network;
determine a number of network-connected client devices on which the deployment of services is to occur, wherein determining a number of network-connected client devices comprises polling the network for client devices and receiving responses from client devices that require the network deployment job; and
create an instance of a network shell script for each network-connected client device, wherein each instance of a network shell script transmits instructions over a parallel network shell to each network connected client device to download packaged job files, wherein the packaged job files comprise at least an auxiliary executable file instructing the client device to implement the network deployment job.

2. The system of claim 1, wherein the packaged job files further comprise a system application file, and wherein instructing the client device to implement the network deployment job comprises implementing the system application file.

3. The system of claim 1, wherein the auxiliary executable file comprises an instruction to self-delete once the network deployment job has been completed on the client device.

4. The system of claim 2, wherein the computer programmable code stored on the at least one memory is further configured to cause the at least one processor to transmit the auxiliary executable file and the system application file over the network shell.

5. The system of claim 1, wherein the network shell script further comprises instructions for the client device to execute the auxiliary executable file.

6. The system of claim 2, wherein transmitting the instructions to the client device to download packaged job files comprises transmitting instructions for the client device to download the auxiliary executable file and the system application file from a file repository server, wherein the instructions to download comprise an address of the location for the auxiliary executable file and the system application file.

7. The system of claim 2, wherein the network deployment job is a system upgrade, and the system application files comprise code to upgrade a network application.

8. The system of claim 1, wherein the network deployment job is a system downgrade, and the auxiliary application file comprises instructions to delete code from a network application.

9. A computer program product for instituting a network-wide deployment of services, the computer program product comprising a non-transitory computer-readable storage medium having computer-executable instructions for:
initiating a network deployment job, wherein the network deployment job comprises the deployment of network services to one or more client devices connected over a network;
determining a number of network-connected client devices on which the deployment of services is to occur, wherein determining a number of network-connected client devices comprises polling the network for client devices and receiving responses from client devices that require the network deployment job; and
creating an instance of a network shell script for each network-connected client device, wherein each instance of a network shell script transmits instructions over a parallel network shell to each network connected client device to download packaged job files, wherein the packaged job files comprise at least an auxiliary executable file instructing the client device to implement the network deployment job.

10. The computer program product of claim 9, wherein the packaged job files further comprise a system application file, and wherein instructing the client device to implement the network deployment job comprises implementing the system application file.

11. The computer program product of claim 9, wherein the auxiliary executable file comprises an instruction to self-delete once the network deployment job has been completed on the client device.

12. The computer program product of claim 9, wherein the auxiliary executable file comprises an instruction to self-delete once the network deployment job has been completed on the client device.

13. The computer program product of claim 9, wherein the network shell script further comprises instructions for the client device to execute the auxiliary executable file.

14. The computer program product of claim 10, wherein transmitting instructions to the client device to download packaged job files comprises transmitting instructions for the client device to download the auxiliary executable file and the system application file from a file repository server, where the instructions to download comprise an address of the location for the auxiliary executable file and the system application file.

15. The computer program product of claim 10, wherein the network deployment job is a system upgrade, and the system application files comprise code to upgrade a network application.

16. The computer program product of claim 9, wherein the network deployment job is a system downgrade, and the auxiliary application file comprises instructions to delete code from a network application.

17. A method for instituting a network-wide deployment of services, the method comprising:
initiating, by a processor, a network deployment job, wherein the network deployment job comprises the deployment of network services to one or more client devices connected over a network;
determining, by a processor, a number of network-connected client devices on which the deployment of services is to occur, wherein determining a number of network-connected client devices comprises polling the network for client devices and receiving responses from client devices that require the network deployment job; and
creating, by a processor, an instance of a network shell script for each network-connected client device, wherein each instance of a network shell script transmits instructions over a parallel network shell to each network connected client device to download packaged job files, wherein the packaged job files comprise at least an auxiliary executable file instructing the client device to implement the network deployment job.

18. The method of claim 17, wherein the packaged job files further comprise a system application file, and wherein instructing the client device to implement the network deployment job comprises implementing the system application file.

19. The method of claim 17, wherein the auxiliary executable file comprises an instruction to self-delete once the network deployment job has been completed on the client device.

20. The method of claim 17 further comprising transmitting, by a processor, the auxiliary executable file and the system application file over the network shell.
